(19) United States
(12) Patent Application Publication
(10) Pub. No.: US 2025/0253678 A1
(43) Pub. Date: Aug. 7, 2025

(54) PASSIVE CELL BALANCING WITH ADAPTIVE PARALLEL BALANCING CIRCUITS

(71) Applicant: Caterpillar Inc., Peoria, IL (US)

(72) Inventors: Avinash P. DONGARE, Bangalore (IN); Bharath BALAKRISHNAN, Kerala (IN); Murali K. RAGHUPATHY, Karnataka (IN)

(73) Assignee: Caterpillar Inc., Peoria, IL (US)

(21) Appl. No.: 18/433,838

(22) Filed: Feb. 6, 2024

(51) Int. Cl. H02J 7/00; H01M 10/42; H01M 10/48

(52) U.S. Cl. CPC H02J 7/0019; H01M 10/48; H02J 7/005; H02J 7/007182; H01M 2010/4271

(57) ABSTRACT

An apparatus includes a battery pack having a plurality of modules, the plurality of modules including a plurality of cells. The apparatus further includes a battery management system (BMS) within the battery pack configured to communicate with one or more signal conditioning devices, the one or more signal conditioning devices each associated with one of the plurality of modules and configured to measure characteristics of cells of an associated module against a threshold. The apparatus further includes a circuit associated with at least one of the plurality of modules. The circuit includes a first cell in series with at least a first resistive element and a second cell in series with at least a second resistive element. The signal conditioning device associated with the circuit is configured to cause the first cell to discharge through the first resistive element and the second resistive element.

### TECHNICAL FIELD

The present disclosure relates generally to one or more aspects of a battery pack system, and more particularly, to systems and methods of passive cell balancing with parallel balancing circuits.

### BACKGROUND

Battery cell balancing enables battery pack systems to have battery cells with similar voltages within a specified voltage range during operation. Cell balancing enhances cell lifespan, among other benefits. Increasingly large battery packs are proliferating in use across the mining and construction fields. Existing hardware and software solutions balance larger battery packs with insufficient speed. These existing balancing procedures pose a risk to cell integrity as a pack ages. Accordingly, cell balancing speeds must be increased to balance larger battery packs.

U.S. Patent Application Publication No. U.S. Pat. No. 7,535,198B2, published on May 19, 2009 (“the '198 patent”), describes a switching circuit for balancing a battery cell. According to the '198 patent, the switching circuit comprises a number of MOSFETs which are used as a switching means. The MOSFET switching circuit is used for balancing the battery cells. While the system described in the '198 patent may be helpful for balancing battery cells, it might not be able to passively balance a cell by using adjacent balancing circuits at a rate 1/n compared to existing implementations, where “n” is the number of adjacent balancing circuits.

The techniques of the present disclosure may solve one or more of the problems set forth above and/or other problems in the art. The scope of the current disclosure, however, is defined by the attached claims, and not by the ability to solve any specific problem.

### SUMMARY

In one aspect, an apparatus may include a battery pack including a plurality of modules, the plurality of modules may include a plurality of cells. The apparatus may further include a battery management system (BMS) within the battery pack configured to communicate with one or more signal conditioning devices, the one or more signal conditioning devices each associated with one of the plurality of modules and configured to measure characteristics of cells of an associated module against a threshold. The apparatus may further include a circuit associated with at least one of the plurality of modules. The circuit may include a first cell in series with at least a first resistive element and a second cell in series with at least a second resistive element. The apparatus may further include a first switching device in parallel with the first cell and the second cell. The signal conditioning device associated with the circuit may be configured to transmit a first signal to a first switching device controller, the first signal may cause the first switching device controller to activate the first switching device to complete the circuit with the first cell and the second cell, and completion of the circuit may cause the first cell to discharge through the first resistive element and the second resistive element.

In another aspect, a method may include measuring a voltage associated with a first cell, the first cell in series with at least a first resistive element. The method may further include determining that the measured voltage is greater than or equal to a threshold, determining that one or more adjacent cells are not currently being balanced, and transmitting a first signal to a switching device controller for a switching device that is in parallel with the first cell and a second cell, the second cell in series with a least a second resistive element. The first signal may cause the switching device controller to activate the switching device to complete a circuit with the first cell and the second cell.

In still another aspect, a method may include measuring, by a signal conditioning device, characteristics associated with a plurality of cells. Each of the plurality of cells may be in series with a respective resistive element of a plurality of resistive elements. The method may further include determining, by the signal conditioning device, that a measured characteristic associated with a first cell of the plurality of cells is greater than or equal to a threshold. The method may further include determining, by the signal conditioning device, that one or more adjacent cells are not currently being balanced. The method may further include transmitting, by the signal conditioning device, a first signal to a plurality of switching device controllers for a respective plurality of switching devices in parallel with the first cell. The first signal may cause the plurality of switching device controllers to activate the respective plurality of switching devices to complete a circuit with the plurality of cells.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a battery system, according to aspects of the disclosure.

FIG. 2 is a circuit, according to aspects of the disclosure.

FIG. 3 provides a flowchart depicting an exemplary method for passive cell balancing with parallel circuits, according to aspects of the disclosure.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of +10% in the stated value.

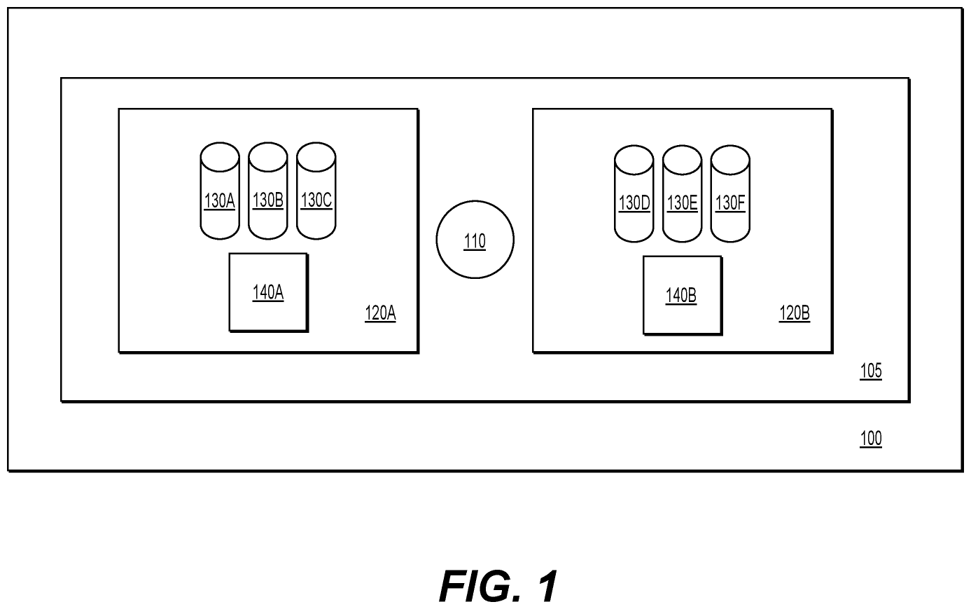

FIG. 1 illustrates a battery system 100, according to aspects of the disclosure. Battery system 100 may be a component of an electric vehicle, though this is only exemplary. Battery system 100 may include a battery pack 105. Battery pack 105 may include a battery management system (BMS) 110. BMS 110 may monitor or control the operation of battery modules 120A-B. As described in more detail elsewhere herein, BMS 110 and/or one or more other pack controllers may monitor the state (e.g., humidity, state of charge (SOC), current, temperature, etc.) of battery modules 120A-B and battery cells 130A-F in battery pack 105, and may control the operations of battery pack 105 to ensure that power is safely and efficiently directed into and out of the battery pack 105.

While a single battery pack 105 is shown in FIG. 1, this is only exemplary and any number of battery packs may be utilized in conjunction with the exemplary embodiments. Battery pack 105 may have a protective housing that encloses the plurality of battery modules 120A and 120B (and other components of the battery pack 105) therein.

Battery pack 105 may include a plurality of modules. While two battery modules, 120A and 120B, are shown in FIG. 1, this is only exemplary and any number of modules may be utilized in conjunction with the exemplary embodiments. It should also be understood that while a plurality of modules (e.g. two), are shown in FIG. 1, one of ordinary skill in the art will appreciate that the exemplary cell balancing apparatus and methods may be implemented with a single module.

In some embodiments, the battery modules 120A-120B may housed in a housing of battery pack 105 and may be separated from each other with dividers (not shown) that provide electrical and thermal insulation. The dividers may protect the other battery modules if any battery module fails (e.g., experiences a high temperature event). The dividers may be made of a material that does not oxidize or otherwise become damaged when exposed to electrical arcs and/or high temperatures. Casings of modules 120A-B may be configured to contain any failures (e.g., electric arcs, fires, etc.) of the battery cells of the battery modules 120A-B within the casing in order to prevent the damage from spreading to other battery modules of the battery pack 105. The casings may be made of any material suitable for this purpose. In some embodiments, the casings may be constructed of one or more of materials such as, for example, Kevlar, aluminum, stainless steel, composite materials, etc. In some embodiments, the casings may be substantially air-tight to hermetically seal the battery cells of the battery modules therein.

Module 120A will be described in further detail below. It should be understood that module 120B, cells 130D, 130E, and 130F, AFE chip 140B are substantially similar to module 120A (and its equivalent components) and will not be described. Module 120A may contain a plurality of cells. While three cells 130A, 130B, and 130C are shown in FIG. 1, this is only exemplary and any number of cells greater than or equal to two may be utilized in conjunction with the exemplary cell balancing apparatus and methods.

The inside structure of one of the battery modules 120A of the battery pack 105 is shown to aid in the discussion below. The battery cells 130A, 130B, and 130C may have any chemistry and construction. In some embodiments, the battery cells 130A, 130B, and 130C may have a lithium-ion chemistry. Lithium-ion chemistry comprises a family of battery chemistries that employ various combinations of anode and cathode materials. In automotive applications, these chemistries may include lithium-nickel-cobalt-aluminum (NCA), lithium-nickel-manganese-cobalt (NMC), lithium-manganese-spinel (LMO), lithium titanate (LTO), and lithium-iron phosphate (LFP), for example. In consumer applications, the battery chemistry may also include lithium-cobalt oxide (LCO), for example.

In general, the battery cells 130A-C may have any shape and structure (e.g., a cylindrical cell, a prismatic cell, a pouch cell, etc.). Typically, all the battery cells 130A-C of a battery module 120A may have the same shape. However, it is also contemplated that different shaped battery cells 130A-C may be packed together. In addition to the battery cells 130A-C, the module 120A may also include sensors (e.g., a temperature sensor, a voltage sensor, a humidity sensor, etc.) and controllers (e.g., a battery module controller) that monitor and control the operation of the battery cells 130A-C. Although not illustrated, the module 120A also may include electrical circuits (e.g., voltage and current sense lines, low voltage lines, high voltage lines, etc.), and related accessories (e.g., fuses, switches, etc.), that direct electrical current to and from the battery cells 130A-C during recharging and discharging

The plurality of battery modules (e.g., 120A and 120B) in battery pack 105, and the plurality of battery cells (e.g., 130A, 130B, and 130C) in each battery module, may also be electrically connected together in series or parallel. In some embodiments, some of the battery modules in a battery pack 105 may be connected together in series, and groups of the series-connected battery modules may be connected together in parallel. Similarly, in some embodiments, a group of battery cells in each battery module may be connected together in series to form multiple series-connected groups of battery cells, and these series-connected groups may be connected together in parallel. That is, some or all battery modules in battery pack 105 may include both series-connected and parallel-connected battery cells. It should be understood that modules 120A and 120B need not be identical according to the exemplary embodiments. The exemplary apparatus and methods may be applied to modules comprising different quantities and types of cells (including those of differing chemistries) within a same battery pack. As an example, a typical battery pack may have six modules, with 36 cells per module therein.

Shown in module 120A is a signal conditioning device 140A, which may include an analog front-end (AFE) chip 140A. AFE chip 140A may receive measured voltages (or signals indicative of measured voltages) associated with one or more cells in a module (e.g., cells 130A-C). AFE chip 140A may determine that a measured cell is outside of a predefined voltage range. One of ordinary skill in the art will appreciate that the predefined voltage range may be a static value, or it may be dynamically adjusted, for example, based on how battery system 100 is being used. In another example, the predefined voltage range may be based on a number of switching devices (or, more specifically, specialized switching devices), which may include metal-oxide-semiconductor field-effect transistors (MOSFETs) or the like, in a given module. When a measured cell voltage is greater than the predefined voltage range, the AFE chip may trigger one or more MOSFETs.

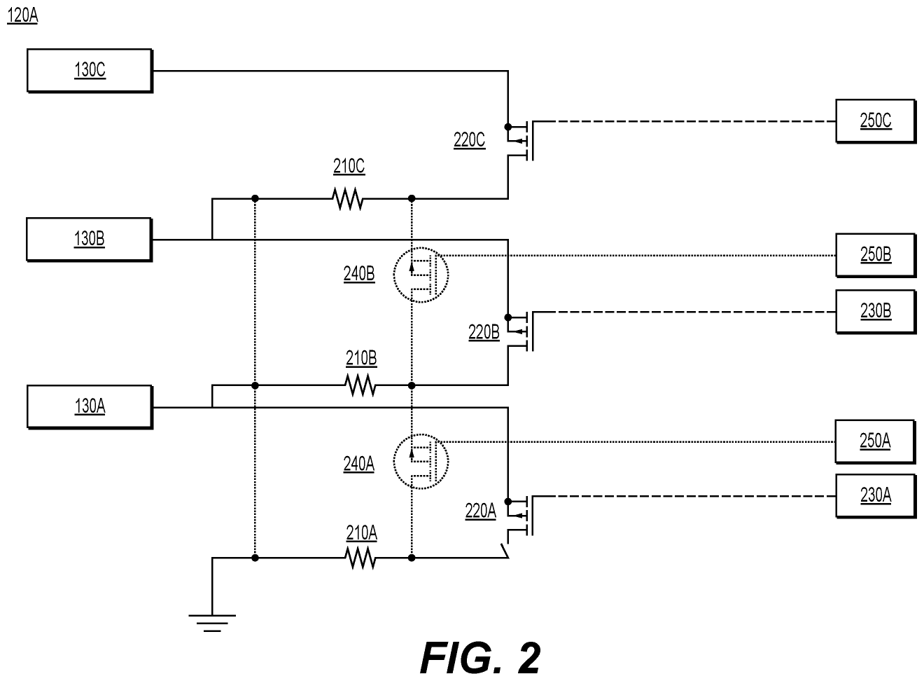

FIG. 2 shows a circuit, according to aspects of the disclosure. The circuit shown in FIG. 2 may be understood to be included within module 120A, though this is only exemplary. Cell 130A may be connected to resistor 210A. A resistor may also be referred to in this disclosure as a “resistive element.” Resistor 210A may help to discharge excess voltage from an overcharged cell to equalize or balance the state of charge with those of surrounding cells. Resistor 210A may also be referred to as a balancing resistor. Resistor 210A may be connected to switch 220A. Switch 220A may be controlled by switch controller 230A to open and close the circuit. Switch controller 230A may receive a signal from the AFE chip 140A to open or close the circuit based on one or more measured characteristics of the circuit. One of ordinary skill in the art will appreciate that cells 130B and 130C, resistors 210B and 210C, switches 220B and 220C, and controllers 230B and 230C are substantially similar to the elements described above.

Shown in FIG. 2 is a MOSFET 240A (or, as discussed above, a switching device 240A) connected in parallel to cells 130A and 130B. Similarly shown is a MOSFET 240B (or, as discussed above, a switching device 240B) connected in parallel to cells 130B and 130C. Unless otherwise noted, MOSFET 240B may be substantially similar in functionality to MOSFET 240A. MOSFET 240A may be connected to a MOSFET controller 250A. MOSFET controller 250A may receive a signal and/or an input from the AFE chip 140A to activate/deactivate MOSFET 240A based on measured voltages of cells 130A, 130B, and/or 130C. Similarly, MOSFET controller 250B may receive a signal and/or an input from the AFE chip 140A to activate/deactivate MOSFET 240B based on measured voltages of cells 130A, 130B, and/or 130C. While three cells and two MOSFETs connected in parallel are shown in FIG. 2, it should be understood that the circuit depicted is only exemplary. The circuit shown in FIG. 2 may feature additional cells, MOSFETs, resistors, controllers, and MOSFET controllers. Similarly, the circuit shown may, in some aspects, be reduced to two cells, a single MOSFET, two resistors, two switches, two controllers, and a single MOSFET controller.

### INDUSTRIAL APPLICABILITY

The disclosed aspects of the battery system 100 of the present disclosure may be used in any machine or device in which battery cells need to be balanced. System 100 enables faster balancing speeds of overcharged cells. If ‘n’ is the number of cell balancing circuits activated to balance a given cell, the balancing duration may be reduced to 1/n times (e.g., reduced by a factor of n). For example, in FIG. 2, if cell 130A is overcharged, and MOSFETs 240A and 240B are activated to complete the parallel balancing circuit, cell 130A will be balanced in one third (1/(n=3)) of the time that would have been needed if the cell 130A were balanced using only resistor 210A. The exemplary aspects of this disclosure may also enable adaptive balancing resistor circuits. For example, different cells in a module may be balanced at different rates as required. In an example, a first cell in a module may be balanced using three adjacent balancing resistors, and a second cell in the module may be balanced using four adjacent resistors. The balancing rate associated with a given cell may depend on, among other criteria, a cell health. This may be helpful as a battery pack degrades over time and balancing demands high cell balancing currents for faster balancing. As noted throughout the disclosure, the exemplary aspects may be applied to any number of cells and accompanying balancing circuits.

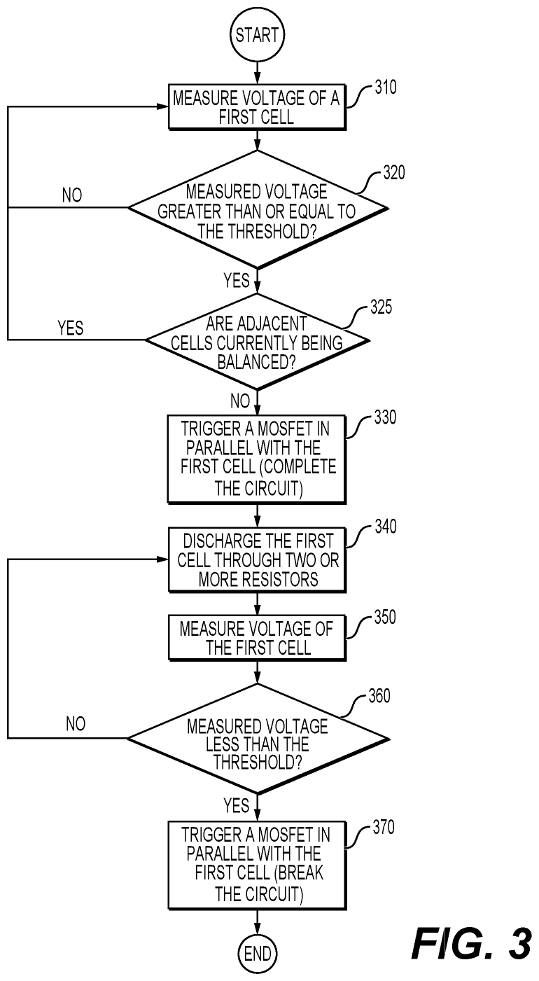

FIG. 3 provides a flowchart depicting an exemplary method for passive cell balancing with parallel circuits, according to aspects of the disclosure. In one embodiment, the steps in FIG. 3 may be performed by a signal conditioning device, such as, for example, AFE chip 140A or the like. In 310, AFE chip 140A measures a voltage associated with a first cell (e.g., cell 130A). While the flowchart of FIG. 3 describes measuring a single cell, it should be understood that the aspects of the disclosure may be applied to multiple cells. For example, AFE chip 140A may continuously measure the voltages of cells 130A, 130B, and 130C.

In 320, AFE chip 140A may determine whether the measured voltage associated with cell 130A is greater than or equal to a threshold. For example, if AFE chip 140A measures a voltage of 3.5 volts on cell 130A, and the threshold is 3.3 volts, AFE chip 140A may proceed to 325. If the measured voltage is less than the threshold, the AFE chip 140A proceeds to 310 and continues to measure the voltage of the first cell (e.g., cell 130A). In some aspects, the threshold may be predefined and static (e.g., 3.3 volts). In other aspects, the threshold may be dynamically determined based on one or more factors such as cell health, module health, pack health, ambient air temperature, cell temperature, module temperature, and pack temperature. Measured voltages greater than the threshold may be associated with a requirement for faster (e.g., greater than one resistor) cell balancing. Measurement of these one or more factors may occur at BMS 110 and be transmitted to one or more AFE chips (e.g., AFE chip 140A). It should be understood that while cell voltages may be measured to determine satisfaction of a threshold, this is only exemplary. Other characteristics of the cell or cells, or characteristics of other components of the system may be compared to a threshold to initiate cell balancing

In 325, AFE chip 140A may determine whether any adjacent cells to cell 130A are currently being balanced (e.g., cell 130B). If any adjacent cells are being balanced, AFE chip 140A returns to 310 to continue measuring the voltage of cell 130A and continues this process until adjacent cells are balanced. If there are no adjacent cells being balanced, AFE chip 140A proceeds to 330.

In 330, after having determined that the measured voltage is greater than or equal to the threshold, and that there is no adjacent cell currently being balanced, the AFE chip 140A may trigger (e.g., activate or turn on) a MOSFET in parallel with the first cell and a second cell to complete a parallel circuit. For example, AFE chip 140A may trigger MOSFET 240A via MOSFET controller 250A. By way of example, AFE chip 140A may send a signal to MOSFET controller 250A upon determining the measured voltage is greater than or equal to the threshold and there is no adjacent cell currently being balanced. MOSFET controller 250A, upon receipt of the signal, may activate MOSFET 240A to complete the parallel circuit. It should be understood that additional MOSFETs may be triggered by AFE chip 140A via additional MOSFET controllers to further increase balancing speed of an overcharged cell.

In 340, the overcharged cell (e.g., cell 130A) may be discharged through resistors 210A and 210B in parallel. In effect, AFE chip 140A discharges the overcharged cell (e.g., cell 130A) by signaling the MOSFET controller 250A to activate the MOSFET 240A. As noted above, the discharge rate of the overcharged cell may be further increased by way of additional MOSFETs and balancing resistors in parallel with the overcharged cell.

In 350, AFE chip 140A may measure the voltage associated with the first cell (e.g., the cell to which the balancing technique has been applied in 330-340). In 360, if the voltage of the first cell is not less than the threshold, the AFE chip 140A allows the overcharged cell additional time to continue discharging in 340. If the measured voltage in 360 is less than the threshold, in 370, AFE chip 140A may trigger (e.g., deactivate or turn off) the MOSFET in parallel with the first cell and the second cell, breaking the parallel circuits and stopping further resistive discharging. By way of example, AFE chip 140A may send a signal to MOSFET controller 250A upon determining the measured voltage is less than the threshold. MOSFET controller 250A, upon receipt of the signal, may deactivate MOSFET 240A to break the parallel circuit. It should be understood that operations 340, 350, and 360 may be performed simultaneously. For example, AFE chip 140A may continuously measure voltages associated with one or more overcharged cells during discharging and compare the measured voltages against the threshold.

The disclosed system and method may facilitate faster cell balancing operations. For example, the system and method may ensure that an overcharged cell is discharged (e.g., balanced) to a threshold more quickly than existing implementations. The system and method may allow for balancing of different cells at different rates. The system and method may be implemented in a variety of fields that require cell balancing, such as in the automotive, heavy industry, and energy storage fields, among other fields.

It will be apparent to those skilled in the art that various modifications and variations can be made to the disclosed system and method without departing from the scope of the disclosure. Other embodiments of the system and method will be apparent to those skilled in the art from consideration of the specification and system and method disclosed herein. It is intended that the specification and examples be considered as exemplary only, with a true scope of the disclosure being indicated by the following claims and their equivalents.

What is claimed is:

1. An apparatus, comprising:
a battery pack comprising a plurality of modules, the plurality of modules comprising a plurality of cells;
a battery management system (BMS) within the battery pack configured to communicate with one or more signal conditioning devices, the one or more signal conditioning devices each associated with one of the plurality of modules and configured to measure characteristics of cells of an associated module against a threshold;
a circuit associated with at least one of the plurality of modules, the circuit comprising:
a first cell in series with at least a first resistive element; and
a second cell in series with at least a second resistive element; and
a first switching device in parallel with the first cell and the second cell,
wherein the signal conditioning device associated with the circuit is configured to transmit a first signal to a first switching device controller, wherein the first signal causes the first switching device controller to activate the first switching device to complete the circuit with the first cell and the second cell, and wherein completion of the circuit causes the first cell to discharge through the first resistive element and the second resistive element.

2. The apparatus of claim 1, wherein the signal conditioning device associated with the circuit is configured to transmit a second signal to the first switching device controller, and wherein the second signal causes the first switching device controller to deactivate the first switching device to break the circuit with the first cell and the second cell.

3. The apparatus of claim 2, wherein the first signal is transmitted to the first switching device controller when the measured characteristic associated with the first cell is greater than or equal to the threshold, and wherein the second signal is transmitted to the first switching device controller when the measured characteristic associated with the first cell is less than the threshold.

4. The apparatus of claim 1, wherein the circuit further comprises:
a third cell in series with at least a third resistive element.

5. The apparatus of claim 4, further comprising:
a second switching device in parallel with the second cell and the third cell,
wherein the signal conditioning device associated with the circuit is configured to transmit a third signal to a second switching device controller, wherein the third signal causes the second switching device controller to activate the second switching device to complete the circuit with the first cell, the second cell, and the third cell, wherein completion of the circuit causes the first cell to discharge through the first resistive element, the second resistive element, and the third resistive element.

6. The apparatus of claim 5, wherein the third signal is transmitted to the second switching device controller when the measured characteristic associated with the first cell is greater than or equal to the threshold.

7. The apparatus of claim 1, wherein the characteristics are cell voltages.

8. A method comprising:
measuring a voltage associated with a first cell, the first cell in series with at least a first resistive element;
determining that the measured voltage is greater than or equal to a threshold;
determining that one or more adjacent cells are not currently being balanced; and
transmitting a first signal to a switching device controller for a switching device that is in parallel with the first cell and a second cell, the second cell in series with a least a second resistive element, wherein the first signal causes the switching device controller to activate the switching device to complete a circuit with the first cell and the second cell.

9. The method of claim 8, wherein the completion of the circuit causes the first cell to discharge through the first resistive element and the second resistive element.

10. The method of claim 8, further comprising:
determining that the measured voltage associated with the first cell is less than the threshold.

11. The method of claim 10, further comprising:
transmitting a second signal to the switching device controller, wherein the second signal causes the switching device controller to deactivate the switching device to break the circuit with the first cell and the second cell.

12. The method of claim 8, wherein the threshold is a static value.

13. The method of claim 8, wherein the threshold is a dynamic value based on at least one of a cell health, a module health, or a pack health.

14. The method of claim 8, wherein the measuring of the voltage is performed by a signal conditioning device, the signal conditioning device associated with the first cell and the second cell.

15. The method of claim 8, wherein the determination that the measured voltage is greater than or equal to the threshold is performed by a signal conditioning device, the signal conditioning device associated with the first cell and the second cell.

16. A method comprising:
measuring, by a signal conditioning device, characteristics associated with a plurality of cells, wherein each of the plurality of cells is in series with a respective resistive element of a plurality of resistive elements;
determining, by the signal conditioning device, that a measured characteristic associated with a first cell of the plurality of cells is greater than or equal to a threshold;
determining, by the signal conditioning device, that one or more adjacent cells are not currently being balanced; and
transmitting, by the signal conditioning device, a first signal to a plurality of switching device controllers for a respective plurality of switching devices in parallel with the first cell, wherein the first signal causes the plurality of switching device controllers to activate the respective plurality of switching devices to complete a circuit with the plurality of cells.

17. The method of claim 16, wherein the completion of the circuit causes the first cell to discharge through the plurality of resistive elements.

18. The method of claim 16, further comprising:
determining, by the signal conditioning device, that the measured characteristic associated with the first cell is less than the threshold.

19. The method of claim 18, further comprising:
transmitting, by the signal conditioning device, a second signal to the plurality of switching device controllers, wherein the second signal causes the plurality of switching device controllers to deactivate the respective plurality of switching devices to break the circuit with the plurality of cells.

20. The method of claim 16, wherein the characteristics are cell voltages, wherein the measured characteristic is a voltage associated with the first cell.
